(19) United States
(12) Patent Application Publication
(10) Pub. No.: US 2026/0300978 A1
(43) Pub. Date: Oct. 1, 2026

(54) TEMPORARY SPEND AUTHORIZATION ENGINE IN A PAYMENT PLATFORM SYSTEM

(71) Applicant: Multi Service Technology Solutions, Inc., Overland Park, KS (US)

(72) Inventors: Daniel Wayne ZIMMERMAN, Overland Park, KS (US); Brandon Dean BLAYLOCK, Prairie Village, KS (US); Lauren Marie TRUJILLO, Roeland Park, KS (US); Daniel Joseph CATES, Overland Park, KS (US); Jeremy DUFF, Overland Park, KS (US); Benjamin WALLIN, Overland Park, KS (US)

(21) Appl. No.: 19/558,244

(22) Filed: Mar. 5, 2026

Related U.S. Application Data
(60) Provisional application No. 63/781,247, filed on Mar. 31, 2025.

(51) Int. Cl. G06Q 20/40

(52) U.S. Cl. CPC G06Q 20/401

(57) ABSTRACT

Methods, systems, and computer storage media for providing temporary spend authorization management using a temporary spend authorization engine in a payment platform system are described. The temporary spend authorization engine is designed to facilitate controlled delegation of purchasing authority using time-limited, one-time-use authorization codes. It allows an authenticated user—typically via a mobile application protected by two-factor and biometric authentication—to temporarily extend purchasing power to a third party without requiring that individual to be formally onboarded into the payment platform. Once authenticated, the user inputs the buyer’s name, phone number, and spending cap. The temporary spend authorization engine generates a unique, expiring code tied to the user’s account and sends it to the buyer. The buyer presents the code and legal identification at the point-of-sale, where the temporary spend authorization engine validates the shared code against preset parameters—verifying its status, purchase limits, and expiration—before authorizing the transaction.

### CROSS REFERENCE TO RELATED APPLICATIONS

This application claims the benefit of U.S. Provisional Patent Application No. 63/781,247, filed on Mar. 31, 2025. The entire contents of which are incorporated by reference herein.

### BACKGROUND

Payment platforms enable users to facilitate secure, seamless transactions by providing a structured environment for processing payments, managing digital credit, and authenticating users. Payment platforms integrate point-of-sale systems, mobile applications, and administrative tools to support real-time purchases, invoicing, and fraud prevention. For instance, when a customer purchases a product online, the payment platform authenticates the user, processes the payment, and manages digital credit. It integrates with point-of-sale systems and mobile apps, enabling real-time purchases and invoicing. Additionally, the platform employs fraud prevention tools, ensuring a smooth, secure transaction experience for both merchants and customers while maintaining a structured financial environment.

### SUMMARY

Various aspects of the technology described herein are generally directed to systems, methods, and computer storage media for, among other things, providing temporary spend authorization management using a temporary spend authorization engine in a payment platform system. Temporary spend authorization management refers to a secure, backend-driven process of generating, distributing, validating, and retiring one-time-use purchase credentials that delegate limited, time-bound spending authority from an authenticated user to a buyer via a payment platform system. The temporary spend authorization engine is designed to facilitate controlled delegation of purchasing authority through the generation and management of time-limited, one-time-use authorization codes. The temporary spend authorization engine allows an authenticated user—typically via a mobile application protected by two-factor and biometric authentication—to temporarily extend purchasing power to a third party (referred to as a “buyer” or “runner”) without requiring that individual to be formally onboarded into the payment platform system.

Once authenticated, the user communicates an indication to generate a temporary code and the temporary spend authorization engine generates a unique, expiring code tied to the user’s account. The user then inputs the buyer’s name, phone number, and a spending cap and communicates and indication (e.g., via a share code button) for the temporary spend engine to send the temporary code to the buyer (e.g., via SMS). On the backend, the temporary spend authorization engine creates a temporary alias buyer record mapped to the primary user, ensuring all transactions made with the shared code remain traceable and auditable. The buyer presents the code and legal identification at a point-of-sale, where the temporary spend authorization engine validates the shared code against preset parameters—verifying its status, purchase limits, and expiration—before authorizing the transaction.

Once the code is used or expires, it is marked inactive and cannot be reused. Metadata including buyer identity and transaction details are logged alongside the original authorized user’s account, preserving transparency while limiting overhead in managing the authorized user’s records. Designed for flexibility and scalability, the temporary spend authorization engine can support configurable usage windows, program-level limits, SKU-level restrictions, and additional features such as barcode/NFC delivery and cancellation features. The temporary spend authorization engine serves as a secure, auditable mechanism for enabling delegated, real-world purchasing without compromising control or oversight.

In operation, in a first embodiment, an authorized user is authenticated via a payment application associated with a payment platform. An indication to generate a temporary code is received at the payment application. The temporary code is a time-limited authorization token that allows a buyer to make a purchase on behalf of the authorized user. Based on receiving the indication to generate the temporary code, the temporary code is generated. An indication to share the temporary code with the buyer is received. Based on receiving the indication to share the temporary code, the temporary code is communicated to a device associated with the buyer.

In a second embodiment, a temporary code associated with a buyer is accessed at a point-of-sale device. The temporary code is a time-limited token that allows the buyer to make a purchase on behalf of an authorized user. The temporary code is communicated to cause validation of the temporary code at a payment platform. Based on communicating the temporary code, a validation response for the temporary code is received. Based on receiving the validation response, an indication of identity verification of the buyer is received. Based on receiving the indication of identity verification of the buyer, a transaction is processed using an account associated with the authorized user.

In a third embodiment, an authorized user is authenticated via a payment platform associated with a payment application. An indication to generate a temporary code for a buyer is received. The temporary code is a time-limited authorization token that allows the buyer to make purchase on behalf of the authorized user. Based on receiving the indication to generate the temporary code, the temporary code is generated. The temporary code is communicated to the payment application. A request to validate the temporary code is received from a point-of-sale device. Based on receiving the request, the temporary code is validated at the payment platform. A validation response is communicated to cause processing a transaction based on the temporary code.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A – 1C are temporary spend authorization schematics associated with a temporary spend authorization workflow of a temporary spend authorization engine, in accordance with aspects of the technology described herein;

FIG. 2A is a block diagram of an exemplary payment platform system including a temporary spend authorization engine, in accordance with aspects of the technology described herein;

FIG. 2B is a flow diagram associated with an exemplary payment platform system including a temporary spend authorization engine, in accordance with aspects of the technology described herein;

FIG. 3 provides a first exemplary method of providing temporary spend authorization management using a temporary spend authorization engine, in accordance with aspects of the technology described herein;

FIG. 4 provides a second exemplary method of providing temporary spend authorization management using a temporary spend authorization engine, in accordance with aspects of the technology described herein;

FIG. 5 provides a third exemplary method of providing temporary spend authorization management using a temporary spend authorization engine, in accordance with aspects of the technology described herein;

FIG. 6 provides a block diagram of an exemplary computing system suitable for use in implementing aspects of the technology described herein;

FIG. 7 provides a block diagram of an exemplary distributed computing environment suitable for use in implementing aspects of the technology described herein; and

FIG. 8 provides a block diagram of an exemplary computing environment suitable for use in implementing aspects of the technology described herein.

### DETAILED DESCRIPTION

### OVERVIEW

A payment platform system provides a set of tools and services that enable authorized users or account holders to initiate, approve, and track purchases made against their credit or pre-funded accounts. These payment platform systems often include web-based dashboards and mobile applications that allow users to view account balances, review transaction histories, make payments, and manage user permissions. Payment platforms are commonly integrated with merchants' point-of-sale (POS) systems or e-commerce platforms, enabling seamless checkout experiences for account holders using established credentials or payment tokens.

Access to purchasing authority within these payment platforms is usually restricted to onboarded users who have completed identity verification and account setup. Each user is associated with a unique identifier, such as a customer ID, phone number, or email address, and must authenticate using standard credentials (e.g., username/password, possibly with two-factor authentication). Purchasing activities are typically tied directly to these users, allowing the system to attribute charges, apply account-level spending limits, and generate itemized invoices. The invoice provides detailed descriptions for each line item, enabling the authorized user to easily verify whether the buyer has purchased the expected items.

Conventionally, payment platform systems are not configured with a comprehensive computing logic and infrastructure to effectively provide controlled delegation of purchasing authority through the generation and management of time-limited, one-time-use authorization codes. Traditional payment platform systems, particularly those used in B2B purchasing environments, are typically designed around static user roles, formal onboarding processes, and persistent authentication methods. While this approach may work well for organizations with stable personnel and predictable workflows, it introduces several key limitations in more dynamic, real-world use cases where purchasing needs are often delegated to third parties on an ad hoc basis.

These payment platform systems require all individuals authorized to make purchases to be formally onboarded into the payment platform. This involves account creation, identity verification, credential setup, and in many cases, administrative approval. As a result, the process of extending purchasing power to new individuals—especially temporary workers or field personnel—can be slow, cumbersome, and operationally impractical. This lack of agility prevents businesses from rapidly responding to real-time purchasing needs in the field. In addition, the onboarding process often may require a valid business email address, which many temporary workers, runners, or subcontractors do not possess. For example, foremen or laborers on job sites may not have corporate email addresses tied to the purchasing entity, effectively disqualifying them from participation in the payment platform. This excludes a segment of the workforce that is frequently responsible for making on-site purchases.

Conventional payment platforms also commonly rely on physical purchasing credentials, such as printed purchase cards, to identify authorized buyers at the point of sale. These physical cards are not only costly to produce and distribute but are also prone to loss, theft, or misuse. Furthermore, sharing a physical card between individuals—though a common workaround—typically violates the card issuer’s terms of service and presents significant security risks, as there is no reliable mechanism for tracking who actually made the purchase.

Payment platform systems may also lack the flexibility to support remote or distributed delegation of purchasing authority. In industries such as construction, service, or maintenance, a foreman may need to quickly authorize different workers at multiple job sites to pick up materials or equipment. Traditional payment platform systems offer no real-time, lightweight mechanism to temporarily delegate purchasing rights to these individuals.

The inability to securely and conveniently extend purchasing power without pre-registration severely limits operational efficiency and creates logistical bottlenecks. Collectively, these limitations highlight the need for a more flexible, secure, and real-time solution that supports temporary delegation of spend authority without requiring full user onboarding or physical credentials. As such, a more comprehensive payment platform system – with an alternative basis for performing temporary spend authorization management – can improve computing operations and interfaces for payment platform systems.

### DESCRIPTION OF TECHNICAL SOLUTION

At a high level, the temporary spend authorization engine is a secure, extensible, mobile-initiated system that enables authorized users to delegate limited, time-bound purchasing authority to third-party individuals—referred to as “buyers” or “runners”—without requiring them to be onboarded into the payment platform. The temporary spend authorization engine enables controlled, auditable, one-time-use (or set-time use) transactions and is designed to integrate seamlessly into existing merchant POS infrastructure with minimal development overhead.

The temporary spend authorization engine begins with a secure login process through a mobile application (“app”) protected by biometric verification and/or two-factor authentication (2FA), ensuring that only authorized users can generate and distribute spend credentials. Credentials are authenticated using enhanced security techniques (e.g., OAuth 2.0 and device-native biometric APIs).

Once authenticated, the user is presented with a code-sharing interface within the app, allowing entry of a buyer’s full name, mobile number, and a spending limit. The temporary spend authorization engine allows users to share multiple codes simultaneously and supports different types of phone numbers with extensibility for other types of formats for sharing the temporary code. Upon submission, the temporary spend authorization engine backend generates a temporary code (e.g., unique 8-digit code) valid for a configurable period—defaulting to 8 hours to cover a full workday scenario. Program administrators may also enforce a program-wide cap that overrides individual user credit lines. For example, even though a user has a $5,000 credit line, the program administrator enforces a $500 program-wide cap, preventing her from issuing a temporary code above that amount.

The generated temporary code is transmitted to the buyer. The code can be communicated to a device associated with the buyer via short message service (SMS) using a third-party gateway including the temporary code, program name, and applicable spending limit. It is contemplated that buyers do not require the mobile app, credentials, or onboarding—solving the problem of individuals lacking business email addresses or not having gone through platform setup. The design assumes minimal friction: the buyer simply presents the temporary code and a valid government-issued ID at the point of sale.

Merchants integrate with temporary spend authorization engine through a lightweight POS Application Programing Interface (API) flow. For example, the POS may provide a user interface to support functionality associated with the temporary spend authorization engine. The POS system transmits the shared code to temporary spend authorization engine, which validates it in real time against backend rules for expiration, usage status, and spending limits. If valid, the API responds with buyer metadata (e.g., name, limit), which is optionally surfaced in the POS user interface (UI) for cashier identity verification. This process supports legal ID matching at checkout ensuring transaction legitimacy.

When a purchase is authorized, temporary spend authorization engine immediately marks the code as “used” and logs the transaction in the authorized user's account. The buyer’s details (name, code, transaction timestamp) are stored in metadata for auditing. To optimize for scale, temporary spend authorization engine uses an append-only temporary alias model rather than creating new user records for each buyer. This approach reduces data bloat and backend maintenance effort. Invoices can be generated in real time, ensuring the authorized user is notified and able to review full line-item details for every transaction.

The temporary spend authorization engine is architected to support a broad range of enhancements that further improve usability, control, and reach. The payment application can include a track code status interface that displays the status of shared temporary codes—such as active, used, expired, or revoked—and allows the authorized user to cancel an unused code in real time, providing greater control, visibility, and security over delegated purchasing activity. Temporary code information includes metadata such as the buyer’s name, phone number, purchase limit, code creation time, expiration timestamps, and usage status.

The cancel code action is a user-initiated control within the interface that sends a cancellation request to the backend, marking the code as inactive and preventing it from being redeemed at the point of sale. For example, an authorized user to cancel a shared code before it is used, giving them full control to revoke access in real time if a situation changes or a mistake is made. In addition, the temporary spend authorization engine supports the development of a shared code history and tracking interface within the mobile application, enabling users to view a log of all codes they’ve issued along with their current status—whether used, expired, or revoked.

To streamline the in-store experience, the temporary spend authorization engine is designed to support barcode, quick-response (QR) code, or NFC-based delivery methods, allowing buyers to simply scan a code at the point of sale instead of manually entering digits. The temporary code is readable at a point-of-sale device to validate the temporary code for use with the purchase and manual entry is also contemplated in an example. Enhancing the mobile interface, temporary spend authorization engine can also be integrated with the user’s contact book, making it faster and more convenient to select and share codes with frequent or known recipients.

The temporary spend authorization engine is further designed with security and compliance features. Unlike traditional card sharing—often a violation of issuer terms—the temporary spend authorization engine ensures identity-bound, one-time-use access with traceability. Both program-level and per-code limits are enforced and the temporary spend authorization engine can track the buyer’s name, access time, and spend amount. By requiring biometric authentication (or other authentication techniques) to access the app and send codes and enforcing legal ID presentation at checkout temporary spend authorization engine delivers higher security than physical cards.

From the end-user perspective, temporary spend authorization engine mirrors the ease of handing over a card or sending a payment via app—but with greater control and security. The ability to generate multiple codes at once, use phone numbers and support distributed teams across job sites or geographies gives it significant real-world utility. The temporary spend authorization engine is especially well-suited for field operations and construction use cases where purchasing needs are urgent and distributed.

### EXAMPLE SYSTEMS AND RESOURCES

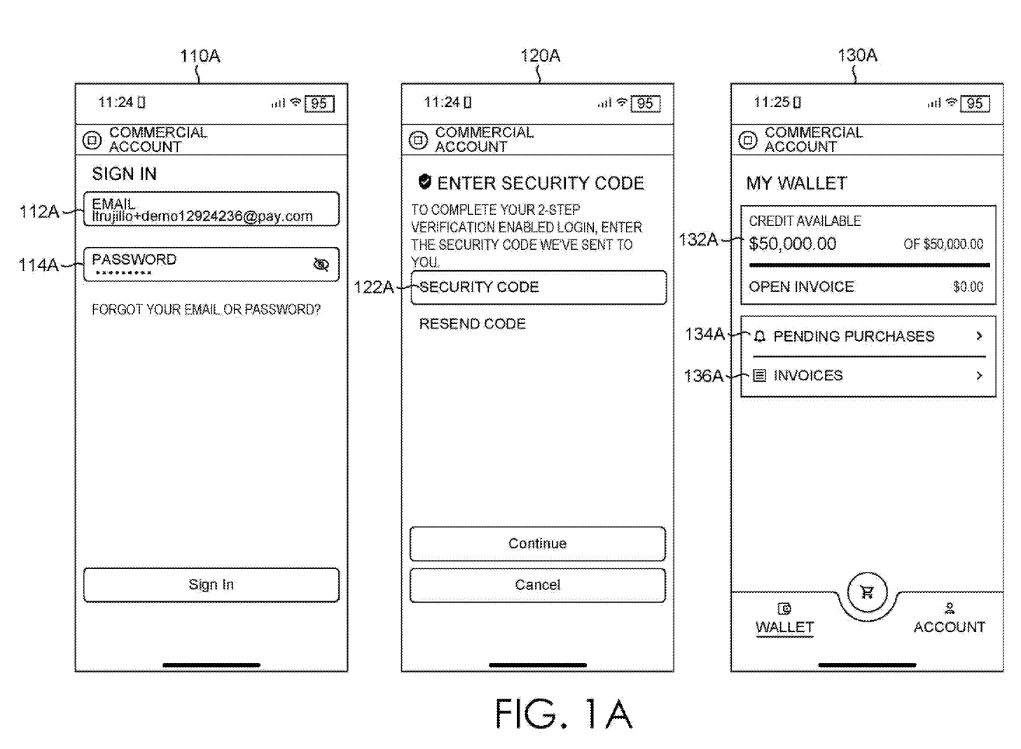

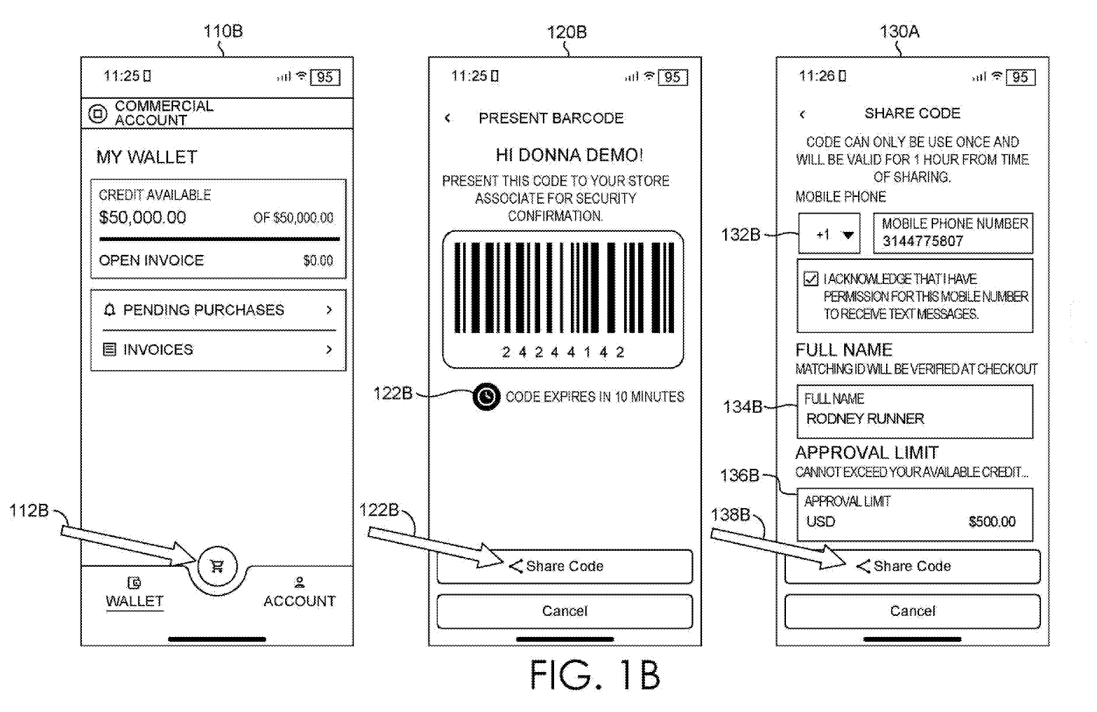

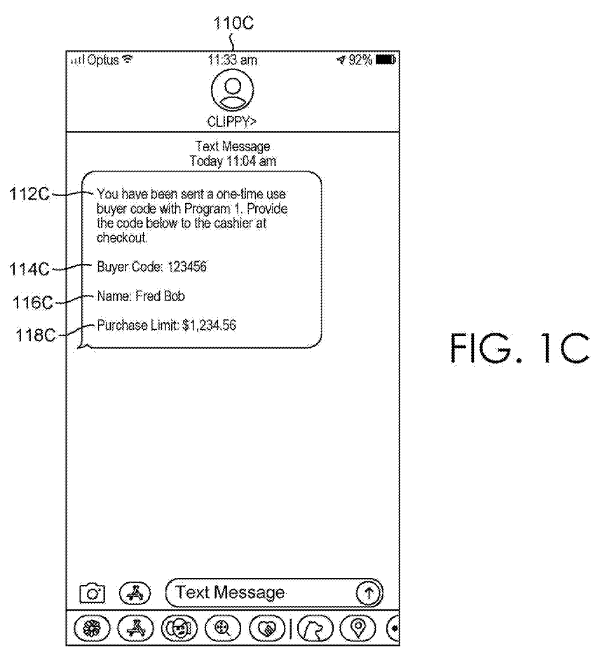

Aspects of the technical solution can be described by way of examples and with reference to FIGS. 1A – 1C, 2A and 2B. With reference to FIG. 1A, FIG. 1A illustrates a temporary spend authorization workflow for providing temporary spend authorization management using a temporary spend authorization engine. FIG. 1A illustrates a user authentication and account overview flow within the context of the temporary spend authorization engine showing how an authorized user gains access to payment platform functions—such as code sharing—via the payment application installed on their mobile device. Each screen maps to distinct operations performed by a user authentication and access control engine and supports secure, role-based access to features within the temporary spend authorization engine.

The first screen 110A represents the Sign In interface, where the user enters their email 112A and password 114A. This login step initiates the temporary spend authorization engine secure authentication process, ensuring that only credentialed individuals—those permitted to delegate purchasing authority—can access the application. After entering valid credentials, the temporary spend authorization engine advances to a two-factor authentication step, shown in the second screen 120A.

In this second screen 120A, the user is prompted to enter a security code in a security code field 122A, where the security code is delivered to them through a separate channel (e.g., SMS or email), as part of the temporary spend authorization engine’s strong authentication protocols. This multi-step process protects against unauthorized access to delegation features such as temporary code generation. Protection against unauthorized access may also be based on biometric authentication, such as facial recognition. When accessing the application through facial recognition, it constitutes strong multi-factor authentication (MFA) as it leverages two distinct factors: possession of the device and biometric verification, in this case, the user’s facial features.

Once authentication is successful, the user is directed to the third screen 130A, which presents the My Wallet dashboard. This interface displays the user’s available credit 132A (up to $50,000 in this example), current financial position, and access points to features such as pending purchases 134A and invoices 136A. While this screen does not yet show the code-sharing interface directly, it represents the post-authentication state from which the user can initiate actions governed by a code generation and configuration engine, such as issuing a temporary code to a buyer.

In the context of temporary spend authorization engine, these screens demonstrate the authentication foundation upon which temporary spend delegation is built. Only after passing through this secure login and verification sequence can an authorized user access functionalities like generating one-time-use codes, defining purchase limits, and reviewing transaction metadata—all of which are essential to enabling secure, auditable, delegated purchasing.

With reference to FIG. 1B, FIG. 1B illustrates the user experience and system logic behind temporary code generation and delivery within the temporary spend authorization engine. It demonstrates how an authorized user, having already authenticated through the payment application, can initiate the process of delegating purchasing authority by creating a one-time-use, time-limited authorization token—known as a temporary code—from their mobile device.

In the first screen 110B, the authorized user is on the My Wallet view, which displays their available credit limit (in this case, $50,000.00) and provides access to financial summaries, including pending purchases and invoices. At the bottom of the screen, the user selects the shopping cart icon 112B, which represents access to delegated purchasing tools, including the ability to issue a shared buyer code.

Upon tapping this icon, the user initiates a workflow handled by a code generation and configuration engine in the backend. The user is taken to the Present Barcode screen 120B. This screen shows a personal barcode that is generated for in-store verification, it also includes an entry point to share a temporary code via “Share Code” button 122B. By tapping this, the app launches the Share Code interface 130B. The Present Barcode screen also show an amount time before the temporary code expires and it is contemplated that the amount time can be configured via the Share Code interface 130B.

The Share Code screen collects essential buyer details, starting with the mobile phone number 132B, which functions as the buyer’s messaging endpoint for receiving the code via SMS. The app also requires the full legal name of the buyer 134B, which will be used for identity verification at the point-of-sale when the buyer redeems the code. This aligns with temporary spend authorization engine’s security requirement that the individual presenting the code be authenticated against a physical ID. Next, the user sets an approval limit 136B, which acts as a purchase limit—in this case, $500.00—capping how much the buyer is authorized to spend. The temporary spend authorization engine enforces this value in real time during code validation.

After verifying the details, the authorized user taps the Share Code 138B button, triggering the backend code generation finalization process. The temporary spend authorization engine links the temporary code to the authorized user account and appends structured metadata such as the user ID, buyer name, mobile number, purchase limit, and expiration timestamp. This data is stored securely in a linking data store within a temporary spend authorization engine database, enabling traceability and auditability.

The temporary spend authorization engine activates a code delivery and buyer access engine, which sends an electronic communication—typically a text message—to the buyer. This message includes the code, merchant information, and instructions for use. The buyer does not need to log in, download an app, or be part of the payment system—a design choice rooted in frictionless onboarding and dynamic delegation.

With reference to FIG. 1C, FIG. 1C illustrates a final delivery step in the temporary spend authorization engine workflow, where a buyer—receives a one-time-use, time-limited authorization token via electronic communication in the form of a text message. The message, shown here in the native messaging app interface 110C on the buyer’s mobile device, originates from a code delivery and buyer access engine, which sends out the authorization payload after the authorized user completes the code generation process within the payment application. It is contemplated that the message may be sent directly from the payment application to a device of the buyer.

The text message 112C contains necessary components for the buyer to complete a transaction at a point-of-sale terminal. It includes a temporary code 114C—in this case, "123456"—which the buyer will present to the cashier at checkout. This code serves as a shared purchase credential and enables the purchase without requiring the buyer to log in or be onboarded to the system, ensuring a frictionless onboarding experience.

The message also includes the full legal name of the buyer 116C, "Fred Bob," which is used for identity verification at the point-of-sale. The cashier will compare this name to the one on the buyer’s ID to confirm the person redeeming the code matches the metadata provided during code generation. This adds a manual, real-world verification layer to the digital authorization. Finally, the message displays a purchase limit 118C, here set to $1,234.56. This limit, defined by the authorized user during the code-sharing process, represents the maximum amount the buyer is permitted to spend. The payment platform’s validation engine will enforce this constraint in real time when the transaction is attempted.

Overall, this SMS encapsulates the output of a secure, auditable delegation event initiated by an authenticated user. It delivers critical data in a simple, scannable format, allowing the runner to transact immediately while the backend maintains full oversight and linkage to the authorized user’s account. This message is the final touchpoint of the temporary spend authorization engine’s dynamic delegation model—extending purchasing power securely, flexibly, and without compromising control.

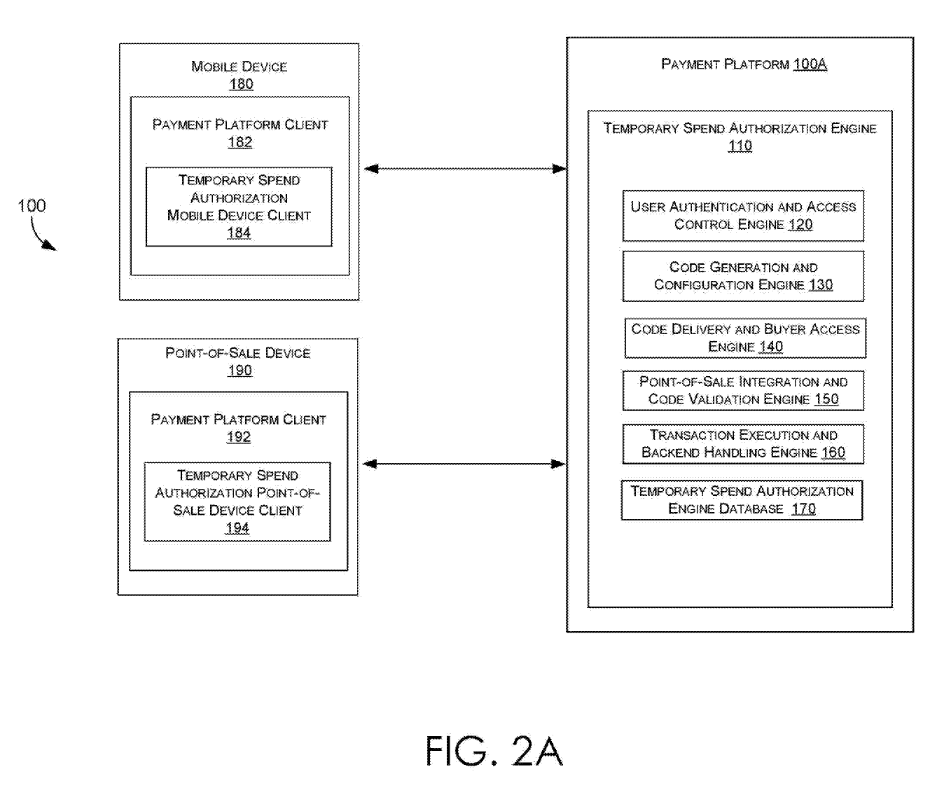

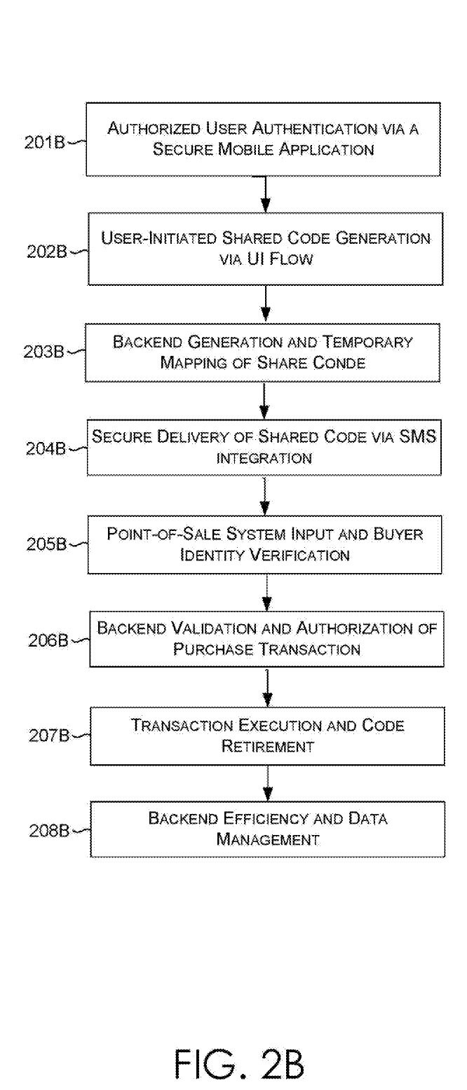

With reference to FIG. 2A, FIG. 2A, illustrates a payment platform system 100 in cloud computing system, payment platform 100A, temporary spend authorization engine 110, user authentication and access control engine 120, code generation and configuration engine 130, code delivery and buyer access engine 140, point-of-sale integration and code validation engine 150, transaction execution and backend handling engine 160, temporary spend authorization engine data 170; mobile device 180, payment platform client 182, temporary spend authorization mobile device client 184; point-of-sale device 190, payment platform client 192, and temporary spend authorization point-of-sale device client 194.

The payment platform system 100 provides the foundational infrastructure for that distributed computing, ensuring that the temporary spend authorization engine 110 can scale efficiently by leveraging cloud-based resources. The payment platform 100A includes the temporary spend authorization engine 110 that enables secure, real-time transactions initiated by an authorized user and executed by a third-party buyer without requiring onboarding. The temporary spend authorization engine 110 is made possible through the interaction of several components including: a mobile device, a point-of-sale (POS) device, and a centralized payment platform.

The process begins on the mobile device 180, where the payment platform client 182 hosts a specialized temporary spend authorization mobile device client 184. Temporary spend authorization mobile device client 184 enables an authorized user—a registered individual with system credentials—to log in and initiate a delegation of purchasing power using strong user authentication and access control measures managed by the user authentication and access control engine 120 within the payment platform 100A. The mobile app collects authentication credentials and may require biometric input or other forms of two-factor authentication to verify the user's identity.

Once authenticated, the authorized user accesses a code-sharing interface via the payment platform client 182, where they input buyer details, such as the buyer’s name and phone number, and define a purchase limit, which constrains how much the buyer may spend. This request is submitted to the code generation and configuration engine 130, which creates a temporary code—a time-limited authorization token uniquely associated with the transaction. This code is also a one-time-use code, meaning it can be used for only a single purchase before becoming permanently invalid.

In some embodiments, the indication to generate the temporary code may be received at the payment application, which may either generate the temporary code locally or forward the request to a temporary spend authorization engine within the payment platform. In the latter case, the temporary spend authorization engine generates the time-limited authorization token and returns it to the payment application for delivery to the buyer. This flexible architecture enables either client-side or platform-side code generation, depending on policy, risk tolerance, or implementation constraints.

The temporary spend authorization engine 110 assigns metadata to the temporary code, including the authorized user ID, code expiration timestamp, the buyer’s information, and any relevant program-level authorization caps, which define the maximum allowable spend for any shared code. For instance, if the available credit for an account is $5,000 and the program's maximum allowable spend for shared codes is $10,000, the temporary spend authorization engine will enforce a limit of $5,000. Conversely, if the available credit for the account is $15,000, the temporary spend authorization engine will enforce the program-level cap of $10,000, ensuring that the expenditure does not exceed the defined threshold, regardless of the account’s available credit.

The generated code is handed off to the code delivery and buyer access engine 140, which initiates an electronic communication—typically an SMS—to the messaging endpoint, which is the buyer’s mobile number. This message contains the temporary code, the name of the merchant, a maximum spend amount if applicable, and instructions for use. This enables frictionless onboarding of the buyer, also referred to as a runner, who does not need a login, application download, or formal system account to make a purchase. This model represents dynamic delegation, in which purchasing power is shared temporarily and on demand.

The buyer then travels to a participating merchant where a point-of-sale device 190 is equipped with a payment platform client 192, which includes a temporary spend authorization point-of-sale device client 194. At checkout, the buyer provides the shared code to the cashier, who uses the POS system’s runner flow to initiate code validation via the point-of-sale integration and code validation engine 150. The point-of-sale integration and code validation engine 150 communicates with the payment platform 100A to send a validation request to an API endpoint, which triggers the platform’s validation logic. The validation process checks the validation criteria, including whether the code exists, is still active, has not expired, has not already been used, and does not exceed the associated purchase limit or program cap.

If the code is valid, the validation response includes confirmation along with select metadata such as the buyer's name and authorized limit. This allows for identity verification at the point of sale, where the cashier compares the buyer's presented ID with the name returned from the temporary spend authorization engine 110. Upon successful match, the transaction proceeds and is logged by the transaction execution and backend handling engine 160, which links the purchase to the authorized user using the temporary alias buyer profile and finalizes the charge.

Once the transaction is complete, the code’s usage status is updated to “used” and logged as a code usage event in the temporary spend authorization engine database 170, which serves as a linking data store. This guarantees the integrity of all transactional records for audit and compliance purposes. Simultaneously, the temporary spend authorization engine 110 initiates invoice generation, creating an invoice with a line-item view with descriptions of each line item for each line item, enabling the authorized user to easily verify whether the buyer has purchased the expected items. The invoice may also optionally include any one of the following: the buyer’s name, purchase amount, timestamp, and any other relevant metadata, which is then returned to the authorized user through the mobile app for transparency and control.

This full cycle—from secure login, mobile-based delegation, code delivery, POS validation, and backend reconciliation—defines a shared purchase credential system that enables mobile-initiated authorization for third-party purchasing while ensuring traceability, compliance, and control over every transaction. The design allows for real-time oversight, seamless buyer participation, and merchant-side enforcement of structured spend policies—all without the need for permanent user onboarding or physical cards.

By way of example, a regional construction company, SteelRidge Contracting, is managing multiple job sites across two states. Jenna, a project supervisor at SteelRidge, is an authorized user on the company’s payment application, which is installed on her mobile device. She is overseeing a site in Spokane, Washington, while another crew is working in Yakima. That crew runs into an urgent problem: they’re out of heavy-duty extension cords and a backup generator has failed. One of the crew leads, Marcus, needs to pick up the replacement equipment immediately from a local hardware store. However, Marcus is not onboarded into the company’s purchasing system, doesn't have a corporate card, and doesn’t use company email.

Using the temporary spend authorization mobile device client, Jenna opens the code-sharing interface in the app and inputs buyer details—Marcus’s full name and phone number. She also sets a purchase limit of $500 to cover only what’s needed. After reviewing the details in the confirmation screen, she submits the request. The code generation and configuration engine on the backend of the payment platform creates a temporary code—a secure, one-time-use, time-limited authorization token—and associates it with metadata including Jenna’s user ID, the $500 limit, Marcus’s name, and a six-hour expiration.

Next, the code delivery and buyer access engine sends Marcus an electronic communication (e.g., an SMS) with the code, the name of the merchant, and instructions for use. Marcus receives the message and heads to the hardware store. At checkout, he tells the cashier he’s using a shared buyer code. The store’s point-of-sale device, which includes the temporary spend authorization point-of-sale device client, launches the runner flow, prompting the cashier to enter the 8-digit code.

The point-of-sale integration and code validation engine sends a validation request to the payment platform’s API endpoint, including the code, merchant ID, and POS metadata. The backend executes validation logic, checking the validation criteria—whether the code exists, is active, unused, unexpired, within Marcus’s $500 purchase limit, and under the store’s program-level authorization cap. The code is valid, and a validation response returns Marcus’s name and the authorization limit.

The cashier then asks Marcus to show his government-issued ID, confirming that the name matches the one returned. With the identity verification complete, the cashier finalizes the purchase. The transaction execution and backend handling engine records the code usage event, marks the code as used, and creates a transaction linking Marcus’s purchase back to Jenna using an alias buyer profile—ensuring Jenna is properly billed.

Moments later, Jenna receives a purchase notification and sees an invoice generation confirmation in her app, displaying a line-item view of what Marcus bought, how much was charged, and when it happened. The transaction’s metadata—code used, timestamp, POS location, buyer identity—is stored in the linking data store within the temporary spend authorization engine database, preserving a complete audit trail for compliance and reporting.

In this scenario, Jenna was able to extend purchasing power in real time, Marcus made the necessary purchase without delay, and the company retained full control, visibility, and traceability—without requiring Marcus to onboard, create a login, or be issued a card. This is the technical solution in action: empowering dynamic delegation through a mobile-initiated authorization system, backed by real-time validation, spending controls, and system integrity.

For clarity and efficient reference, a glossary of key terms and concepts pertinent to the technical solution is provided below.
Alias Buyer Profile: A temporary identity created by the backend to process a purchase made using a shared code. It is internally mapped to the authorized user but prevents the creation of a permanent buyer account for the buyer.
API Endpoint: A defined URL interface exposed by the payment platform that allows external systems, such as merchant point-of-sale (POS) systems, to validate temporary codes in real time.
Audit Trail: An immutable log of events associated with temporary code generation, usage, validation, and transaction execution, including metadata for compliance and recordkeeping.
Authorized User: A verified participant in the payment platform with the ability to generate temporary spend authorization codes and delegate purchasing authority to a third party.
Buyer (also: Runner): A third party who receives a temporary code from an authorized user to make a purchase at a participating point-of-sale, without being onboarded into the payment platform.
Buyer Details: Information provided by the authorized user about the buyer during code generation, typically including the buyer’s full name and mobile phone number.
Code Cancellation: The process by which an authorized user revokes a temporary code before it is used, preventing the buyer from completing a transaction with that code.
Code Expiration Time: The predefined time limit assigned to a temporary code after which it becomes invalid. Common default is 8 hours from code generation.
Code Generation: The backend operation that creates a one-time-use or set-time use, time-limited authorization token based on inputs from an authenticated authorized user.
Code Sharing Interface: A user interface within the payment application where the authorized user inputs buyer details and optionally sets a spending limit to initiate the creation of a temporary code.
Code Status: The current lifecycle state of a temporary code (e.g., active, used, expired, revoked), which determines whether it is valid for transaction processing.
Code Usage Event: A recorded system event triggered when a temporary code is redeemed, including details such as timestamp, transaction amount, and buyer information.
Confirmation Screen: A UI element in the payment application that displays buyer information and spend limit for review before the authorized user finalizes the code-sharing action.
Delegated Purchasing Authority: The act of temporarily transferring purchasing rights from an authorized user to a buyer via a shared code.
Dynamic Delegation: The real-time ability for an authorized user to assign, track, and manage temporary spend authorization codes without pre-planned administrative workflows.
Electronic Communication: A message sent to the buyer containing the temporary code, typically via SMS, and optionally including purchase limit and usage instructions.
Frictionless Onboarding: A design philosophy that allows buyers to make purchases without needing to create an account, download an app, or provide credentials.
Identity Verification: The process of confirming the buyer's identity at the point-of-sale by matching a government-issued ID to the name associated with the temporary code.
High-security alternatives to government-issued ID include company-issued photo badges, digital IDs from authorized apps, and temporary driver’s permits. Moderate options like bank cards, student IDs, and job tickets work for low-risk cases. Low-security methods include verbal confirmation or facial recognition, with varying trade-offs in scalability and control.
Invoice Generation: The backend process of creating a line-item invoice for a transaction made with a temporary code, linked to the authorized user’s account and buyer metadata.
Line-Item View: A detailed breakdown of a transaction in an invoice, showing individual charges, SKU, description, quantity, unit price, tax amounts and details, discount amounts, and subtotal and total amounts.
Linking Data Store: A datastore that persistently or temporarily associates temporary codes with their originating authorized users, corresponding buyer information, transaction metadata, and status changes (e.g., active, used, expired). It supports traceability by maintaining durable relationships between code issuance events and purchase outcomes.
Merchant Identifier: A unique value included in validation requests that identifies the merchant or location initiating the transaction.
Messaging Endpoint: The destination (typically a mobile phone number) used to deliver the temporary code and instructions to the buyer.
Metadata: Structured data attached to each temporary code and transaction, including the authorized user ID, buyer information, expiration time, code status, purchase limit, and point-of-sale details.
Mobile-Initiated Authorization: The process of creating and sharing a temporary code entirely from the authorized user’s mobile device without external system coordination.
One-Time-Use Code: A temporary code that can be redeemed for a single transaction only. It becomes permanently invalid after use.
Payment Application: The mobile app interface associated with the payment platform through which the authorized user logs in, shares codes, manages delegation, and views invoices.
Payment Platform: The backend infrastructure that handles authentication, code generation, code validation, transaction processing, metadata storage, and invoicing.
Point-of-Sale Device (POS): A merchant-side terminal or software interface used to validate temporary codes and process purchases made by buyers using those codes.
Program-Level Authorization Cap: A global or merchant-defined limit on the maximum amount that can be spent using shared codes, regardless of the authorized user’s individual credit line.
Purchase Limit: A dollar cap set by the authorized user to restrict how much a buyer can spend when using a particular temporary code.
Purchase Notification: A system-generated alert or message that informs the payment application or platform that a transaction using a temporary code has occurred.
Redemption Flow: The sequence of steps in which a buyer presents a temporary code at the point-of-sale, completes ID verification, and finalizes a purchase using the code.
Runner Flow: A special POS interface flow used to handle transactions involving temporary codes issued to runners.
Set-time Use: Refers to a condition applied to a digital credential, code, or authorization token that restricts its validity to a specific time window. The code remains valid only between a defined start time and expiration time, regardless of whether it is used. Once the time window expires, the code becomes invalid and cannot be redeemed—even if it was never used.
Shared Buyer Code: Another term for a temporary code; a one-time-use credential generated by an authorized user to allow a non-onboarded buyer to make a purchase.
Shared Purchase Credential: A generic term for any token (code, QR, NFC) shared with a buyer to authorize temporary purchasing power.
Structured Error Message: A predefined response returned when code validation fails (e.g., “code expired,” “code used,” “over limit”), allowing the POS to respond appropriately.
Temporary Code: A secure, one-time-use, time-limited token generated by an authorized user that enables a buyer to make a transaction on their behalf without needing login credentials.
Time-Limited Authorization Token: A credential that is valid only for a defined period after generation (e.g., 8 hours), after which it automatically expires and cannot be used.
Track Code Status Interface: An interface in the payment application that lets the authorized user view all issued temporary codes, their statuses, and optionally cancel them.
Transaction Linking: The process of associating a purchase made with a temporary code to the authorized user’s account for billing, invoicing, and audit purposes.
Two-factor Authentication Input: This is secondary form of verification used to confirm a user's identity, typically required after entering a primary credential such as a password. It may include a time-sensitive code sent via SMS or email, a code generated by an authenticator app, biometric data (e.g., fingerprint or facial recognition), or a physical security token. This input enhances security by requiring something the user knows (e.g., password) and something the user has or is (e.g., device or biometric) before granting access.
Usage Status: A flag that indicates whether a temporary code is unused, used, expired, or revoked.
Validation Criteria: The conditions that must be met for a code to be accepted at the POS, including existence, active status, expiration, usage, purchase limit, and program cap.
Validation Logic: The backend mechanism that evaluates a temporary code against system rules during a validation request.
Validation Request: A data packet sent from a POS to the payment platform to determine whether a temporary code is eligible for use.
Validation Response: The structured reply from the platform after validating a temporary code, which may include buyer details, purchase limits, or an error code.

With reference to FIG. 2B, FIG. 2B a flow chart 200B associated with providing a temporary spend authorization management using a temporary spend authorization engine in accordance with embodiments described herein. The technical solution of the temporary spend authorization engine can be explained by way of steps.

At step 201B: Authorized User Authentication via Secure Mobile Application

To initiate a shared purchasing authorization, an authorized user must first authenticate within a secure mobile application. The temporary spend authorization engine enforces two-factor authentication (2FA) at login, requiring a valid username and password combination in conjunction with either biometric credentials (e.g., fingerprint or facial recognition) or a secondary one-time passcode delivered via SMS or email. This ensures that only verified and credentialed individuals can access the purchasing authority management features. The mobile application leverages established security protocols such as OAuth 2.0 and biometric authentication APIs native to the device’s operating system to guard against unauthorized access and credential spoofing.

At step 202B: User-Initiated Shared Code Generation via UI Flow

Upon successful authentication, the authorized user is presented with a dedicated “Share Code” interface within the mobile application. This user interface allows the authorized user to designate a buyer by entering the buyer’s legal full name and a valid mobile phone number. Optionally, the user may impose a transaction-specific purchase limit, which may be less than the account’s available credit line. The application may also include an acknowledgement checkbox whereby the user confirms authorization to send SMS messages to the provided phone number. This flow ensures a controlled and auditable delegation of purchasing authority with minimal administrative friction.

At step 203B: Backend Generation and Temporary Mapping of Shared Buyer Code

Once the user completes the code-sharing form, the mobile application submits a request to a backend API to initiate generation of a unique shared buyer code. The backend system generates a random, one-time-use alphanumeric code (e.g., an 8-digit numeric string), assigns a configurable expiration period (defaulting to 8 hours), and stores it in a secure database along with associated metadata—such as the original buyer’s ID, runner details, timestamp, expiration time, and optional purchase limit. Rather than instantiating a new buyer record in the database, the system creates a temporary alias buyer profile linked to the originating buyer. This strategy ensures transactional traceability without burdening the system with excess user records or long-term database growth.

At step 204B: Secure Delivery of Shared Code via SMS Integration

After generation, the shared buyer code is dispatched to the designated runner through an automated SMS message sent via a secure messaging gateway, such as Twilio. The message contains the program name, shared code, maximum allowable purchase amount (if any), and a brief instruction to present the code to a cashier at checkout. Since the runner does not require access to the mobile application, and may not be a registered program user, SMS delivery ensures broad accessibility and aligns with the intended frictionless use case—empowering authorized users to delegate purchasing authority to non-onboarded individuals securely and instantly.

At step 205B: Point-of-Sale System Input and Runner Identity Verification

At the retail point of sale (POS), the buyer presents the shared code and is prompted to show valid legal identification. The cashier navigates to a custom “runner” flow in the POS software, inputs the eight-digit code, and submits it to the backend verification API. Upon receiving the code, the temporary spend authorization engine cross-references it with stored values to confirm the code is active, unused, unexpired, and within the pre-defined purchase limits. In the same response, the API returns the runner’s name and purchase limit to the POS interface, enabling the cashier to visually match the presented identification with the authorized runner’s name. This manual verification step adds an additional layer of security to prevent fraudulent use of shared codes.

At step 206B: Backend Validation and Authorization of Purchase Transaction

The backend API processes the POS request by validating the one-time-use shared code against internal records. Validation checks include: (i) confirming the code exists, (ii) ensuring it is associated with an active program and authorized buyer, (iii) verifying that it has not expired or been previously used, and (iv) validating that the total purchase value does not exceed either the code-level or program-level credit limits. Upon successful validation, the backend returns a structured response containing the alias buyer ID, runner metadata, program configuration, and an approval token for the transaction. If any validation step fails, an appropriate error response (e.g., “code expired,” “exceeds limit”) is returned to the POS system.

At step 207B: Transaction Execution and Code Retirement

Following successful validation, the retail system proceeds to complete the transaction under the authority of the alias buyer, which is internally mapped to the authorized user. The shared code is immediately marked as “used” in the backend system, thereby rendering it invalid for any future attempts. Metadata related to the runner (e.g., name, phone number, transaction timestamp) is appended to the charge record. This approach preserves billing continuity by attributing the purchase to the authorized user while retaining an auditable trail indicating that the transaction was executed on their behalf by a designated runner. The system can optionally include the runner’s name in the invoice metadata for enhanced transparency.

At step 208B: Backend Efficiency and Temporary Data Management

To preserve temporary spend authorization engine performance and scalability, the backend architecture is optimized to avoid the creation of persistent user records for buyers. Instead, all shared code transactions are handled through ephemeral alias mappings linked to the originating authorized user. These mappings are maintained only for the life of the code or until the transaction is completed, at which point the system archives or discards them according to configured retention policies. This append-only, alias-based model minimizes unnecessary database bloat, reduces maintenance complexity, and simplifies long-term data management—especially in high-volume environments where codes may be generated and consumed frequently.

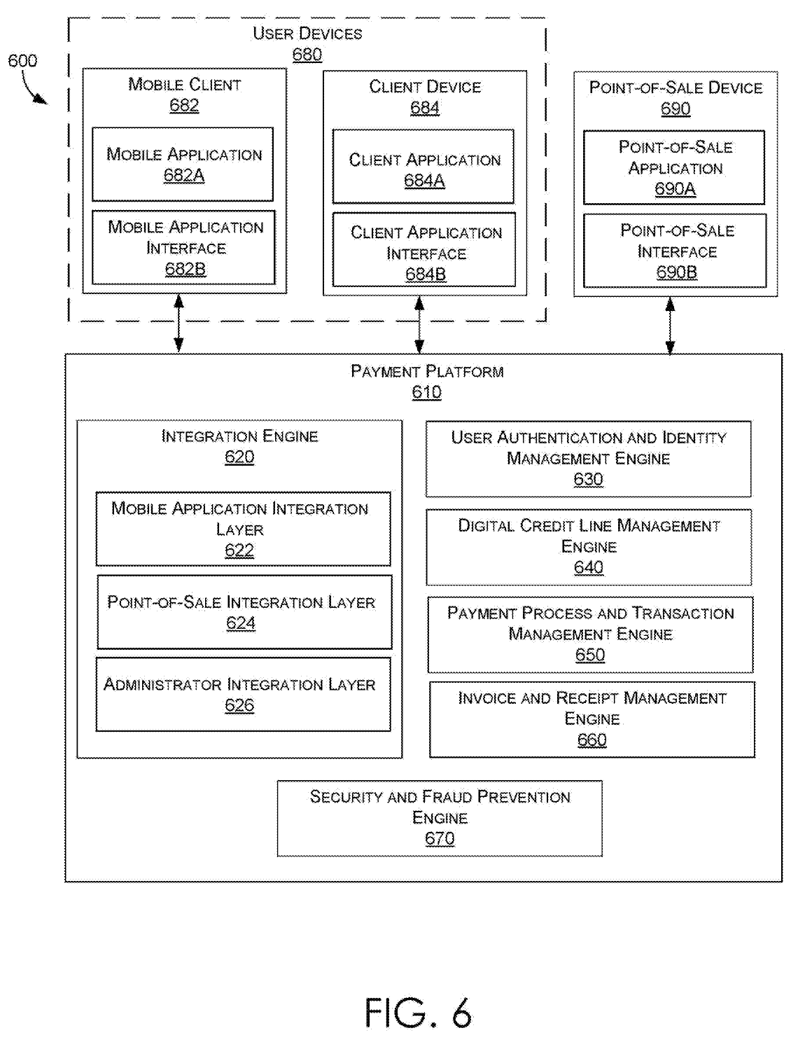

Aspects of the technical solution have been described by way of examples and with reference to FIGS. 1A – 1C, 2A and 2B. FIG. 2A is a block diagram of an exemplary technical solution environment, based on example environments described with reference to FIGS. 6, 7 and 8 for use in implementing embodiments of the technical solution are shown. Generally the technical solution environment includes a technical solution system suitable for providing the example payment platform system 100 in which methods of the present disclosure may be employed. In particular, FIG. 2A illustrates a high-level architecture of a cloud computing system associated with the payment platform system 100 in accordance with implementations of the present disclosure, among other engines, managers, generators, selectors, or components not shown (collectively referred to herein as “components”).

### EXAMPLE METHODS

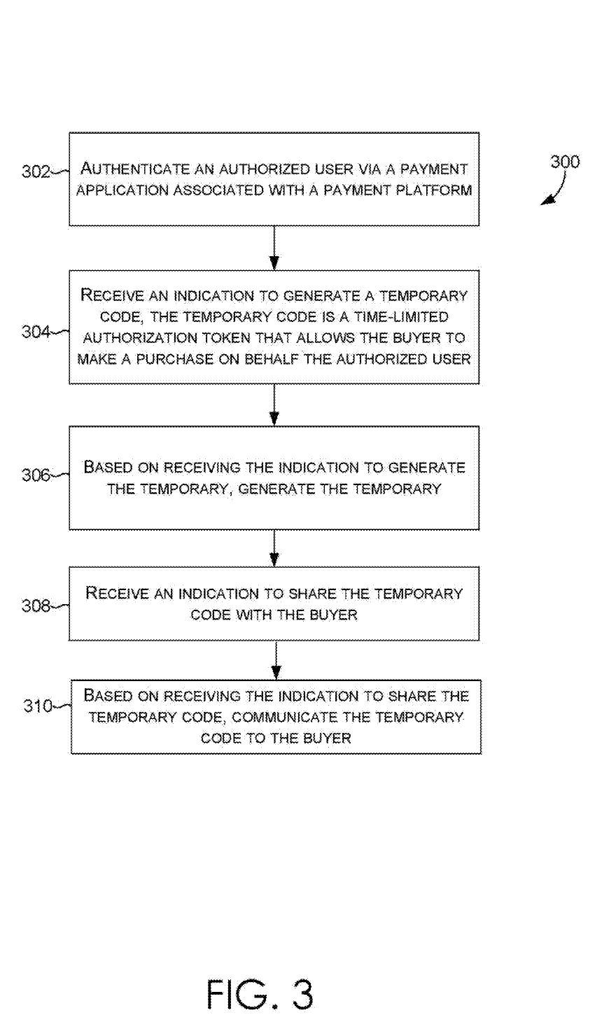

With reference to FIGS. 3, 4, and 5, flow diagrams are provided illustrating methods for providing temporary spend authorization management using a temporary spend authorization engine in a payment platform system. The methods may be performed using the payment platform system described herein. In embodiments, one or more computer-storage media having computer-executable or computer-useable instructions embodied thereon that, when executed, by one or more processors can cause the one or more processors to perform the methods (e.g., computer-implemented method) in the payment platform system (e.g., a computerized system).

Turning to FIG. 3, a flow diagram is provided that illustrates a method 300 for providing temporary spend authorization management using a temporary spend authorization engine in a payment platform system. At block 302, authenticate an authorized user via a payment application associated with a payment platform. At block 304, receive an indication to generate a temporary code, wherein the temporary code is a time-limited authorization token that allows a buyer to make a purchase on behalf of the authorized user. At block 306, based on receiving the indication to generate the temporary code, generate the temporary code. At block 308, receive an indication to share the temporary code with the buyer. At block 310, based on receiving the indication to share the temporary code, communicate the temporary code to the buyer.

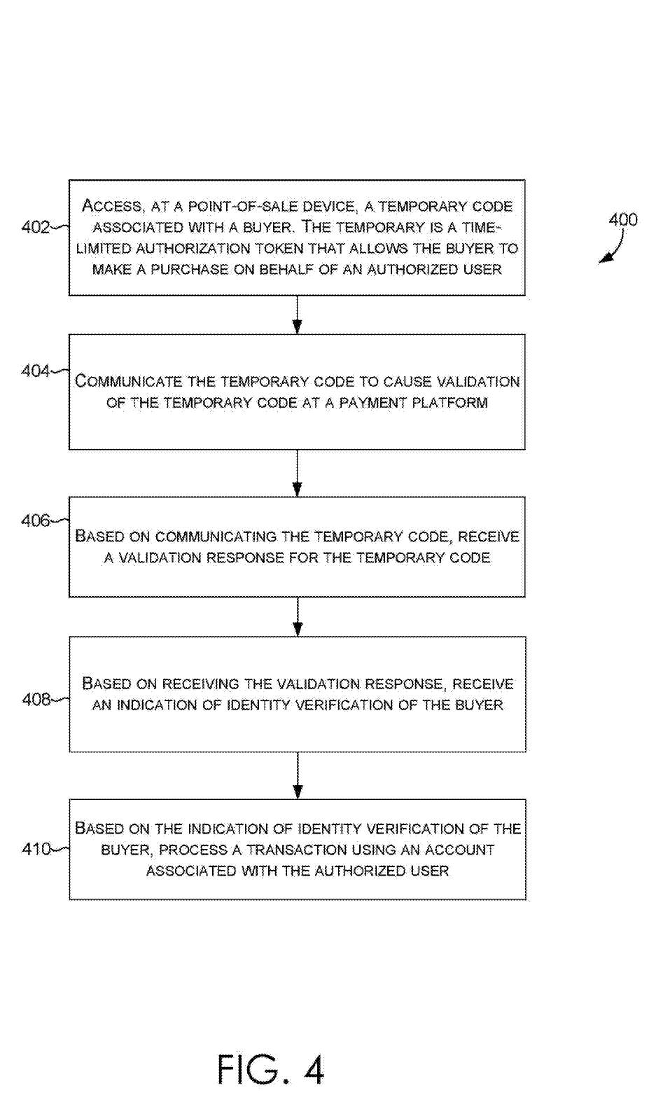

Turning to FIG. 4, a flow diagram is provided that illustrates a method 400 for providing temporary spend authorization management using a temporary spend authorization engine in a payment platform system. At block 402, access, at a point-of-sale device, a temporary code associated with a buyer, wherein the temporary code is a time-limited authorization token that allows the buyer to make a purchase on behalf of an authorized user. At block 404, communicate the temporary code to cause validation of the temporary code at a payment platform. At block 406, based on communicating the temporary code, receive a validation response for the temporary code. At block 408, based on receiving the validation response, receive an indication of identity verification of the buyer. At block 410, based on the indication of identity verification of the buyer, process a transaction using an account associated with the

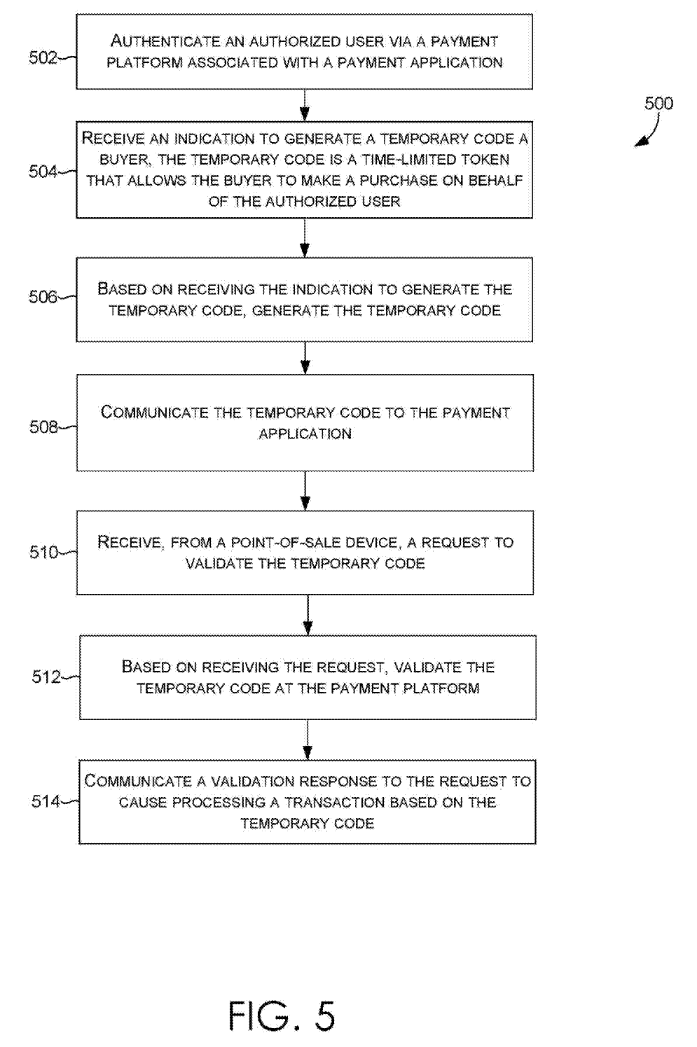

Turning to FIG. 5, a flow diagram is provided that illustrates a method 500 for providing temporary spend authorization management using a temporary spend authorization engine in a payment platform system. At block 502, authenticate an authorized user via a payment platform associated with a payment application. At block 504, receive an indication to generate a temporary code for a buyer, wherein the temporary code is a time-limited authorization token that allows the buyer to make a purchase on behalf of the authorized user. At block 506, based on receiving the indication to generate the temporary code, generate the temporary code. At block 508, communicate the temporary code to the payment application. At block 510, receive, from a point-of-sale device, a request to validate the temporary code. At block 512, based on receiving the request, validate the temporary code at the payment platform. At block 514, communicate a validation response to the request to cause processing a transaction based on the temporary code.

### TECHNICAL IMPROVEMENT

Embodiments of the present techniques have been described with reference to several inventive features (e.g., operations, systems, engines, and components) associated with a payment platform system. Inventive features described include operations, interfaces, data structures, and arrangements of computing resources associated with providing the functionality described herein relative with reference to a temporary spend authorization engine. Functionality of the embodiments of the present invention have further been described, by way of an implementation and anecdotal examples – to demonstrate that the operations for providing the temporary spend authorization engine as a solution to a specific problem in payment systems technology to improve computing operations in payment platform systems.

By way of illustration, the temporary spend authorization engine enables a verified, authorized user to securely delegate purchasing authority to a non-onboarded individual—referred to as a buyer or runner—through the use of a temporary, one-time-use authorization code. This process is initiated through a mobile payment application, where the authorized user signs in using two-factor authentication, then accesses a code-sharing interface to input buyer details (such as name and phone number), set an optional spending limit, and generate a temporary code with a built-in expiration timestamp. The backend platform assigns metadata to the code and stores it in an append-only data store. The code is delivered via electronic communication (e.g., SMS) to the buyer’s mobile device.

At the point of sale, the buyer presents the code and a valid ID, which is verified against the stored metadata. A point-of-sale device, integrated with the payment platform, validates the code through an API request that checks for existence, expiration, usage status, and applicable limits. Upon successful validation, the purchase is completed, and the code is marked as used. The backend platform links the transaction to the authorized user, logs all relevant metadata, and generates a detailed invoice that includes the buyer’s name, purchase amount, and timestamp for compliance and audit purposes.

This technical solution presents a specific, non-abstract improvement over traditional payment systems by solving the problem of extending secure purchasing power to non-onboarded individuals—without compromising security, traceability, or control. Unlike conventional approaches that rely on physical card handoff or require full account onboarding, this system enables dynamic, real-time spend delegation via temporary authorization codes that are uniquely generated, metadata-rich, and tightly bound to system-enforced rules. The code is validated through an integrated backend engine using structured logic that considers expiration, purchase limits, and usage status—moving well beyond generic code redemption or basic data transmission.

The temporary spend authorization engine employs a combination of authentication layers, ephemeral token generation, structured validation workflows, and real-time metadata association to create a new method of enabling controlled third-party transactions. Because it includes technical features such as append-only data structures, API-driven code validation, and point-of-sale integration, the invention is rooted in concrete technological architecture—not a mere mental process or business practice. These improvements transform an abstract concept (delegated spending) into a functional system with defined user flows, backend enforcement logic, and auditable outputs.

### ADDITIONAL SUPPORT FOR DETAILED DESCRIPTION

### EXAMPLE PAYMENT PLATFORM SYSTEM IN A COMPUTING ENVIRONMENT

Referring now to FIG. 6, FIG. 6 illustrates a computing environment in which implementations of the present disclosure may be employed. In particular, FIG. 6 shows a high-level architecture of an example payment platform system 600 and payment platform 610 that can host a technical solution environment. Payment platform system 600 enabled secure, credit-based business-to-business (B2B) transactions via a mobile-enabled payment platform 610. Payment platform system 600 facilitates contactless, real-time commercial transactions between authorized purchasers and participating merchants, utilizing pre-approved digital credit lines, mobile client devices, and point-of-sale infrastructure without reliance on physical payment cards or manual invoicing.

Payment platform system 600 comprises a plurality of interconnected subsystems, including user devices 680 and a centralized payment platform 610. The user devices 680 include at least a mobile client 682, a client device 684, and a point-of-sale (POS) device 690. The mobile client 682 is configured to execute a mobile application 682A, which provides access to a mobile application interface 682B. The mobile client 682 enables an authorized user to authenticate, access a pre-approved credit line, generate a transaction code, and initiate a payment transaction at a merchant location.

The client device 684 is configured to execute a client application interface 684B, operatively coupled to a client application interface 684B. In various embodiments, the client device 684 may be utilized for administrative or supervisory functions, including credit line monitoring, transaction history review, or user profile management. The POS device 690 is configured to execute a point-of-sale application 690A and provide a point-of-sale interface 690b for accepting input from a mobile client 682 during a transaction. The POS device 690 may include optical scanning components, NFC readers, or other mechanisms for receiving transaction credentials generated by the mobile client 682.

The backend infrastructure of the payment platform system 600 is embodied in payment platform 610, which comprises a plurality of logical engines and integration layers. The integration engine 620 includes a mobile application integration layer 622 configured to facilitate bi-directional communication between the mobile client 682 or client device 684 and the payment platform 610. The integration engine 620 further comprises a point-of-sale integration layer 624, operable to interface with point-of-sale device 690, and an administrator integration layer 626, configured to provide control and configuration access to system administrators via an administrator device (not shown).

User authentication and identity management engine 630 is operative to validate user credentials, enforce access control policies, and manage session authorization. In some embodiments, user authentication and identity management engine 630 may employ multi-factor authentication (MFA) protocols, role-based access control (RBAC), and real-time identity verification procedures to ensure secure and restricted access to payment platform system 600.

Digital credit line management engine 640 is configured to manage the assignment, utilization, and monitoring of pre-authorized credit lines associated with registered business users. The digital credit line management engine 640 may be further operable to adjust credit availability dynamically based on transaction activity, administrative rules, or external creditworthiness assessments. In at least one embodiment, credit lines may be accessed by a user immediately upon approval, without issuing a physical payment instrument.

Payment process and transaction management engine 650 coordinates the end-to-end processing of transactions initiated via the mobile application 682A. This includes validation of transaction credentials, verification of credit availability, authorization of the transaction, and generation of transaction metadata. Upon successful transaction processing, relevant data is transmitted to invoice and receipt management engine 660.

Invoice and receipt management engine 660 is operative to generate and transmit digital invoices and receipts to the appropriate recipient systems or personnel. In various embodiments, invoices may be transmitted via email, integrated with enterprise resource planning (ERP) systems, or archived within a centralized database accessible via client application interface 684B or mobile application interface 682B. The invoice and receipt management engine 660 reduces reliance on physical receipts and manual invoice generation, thereby improving operational efficiency.

Security and fraud prevention engine 670 operates in conjunction with other system components to detect and prevent unauthorized access, malicious activity, or anomalous transaction behavior. The security and fraud prevention engine 670 may leverage tokenized communication, encrypted transaction payloads, behavioral analysis algorithms, and usage pattern recognition to maintain system integrity and data confidentiality.

In operation, a user employing mobile client 682 authenticates via mobile application 682A and is granted access to a digital credit line managed by digital credit line management engine 640. Upon selecting a product or service at a merchant’s location, the user may generate a scannable or contactless transaction code. This code is presented to POS device 690, which interacts with payment process and transaction management engine 650 via point-of-sale integration layer 624. Upon validation and approval, a transaction is completed, and invoice and receipt data are generated and disseminated as appropriate. Transactions can be continuously monitored by security and fraud prevention engine 670.

The payment platform system 100 provides a comprehensive, modular framework for enabling secure, mobile-first B2B transactions, eliminating the need for physical cards, streamlining the invoicing process, and delivering an experience analogous to consumer digital wallets, but adapted for enterprise-grade credit workflows.

### EXAMPLE DISTRIBUTED COMPUTING SYSTEM ENVIRONMENT

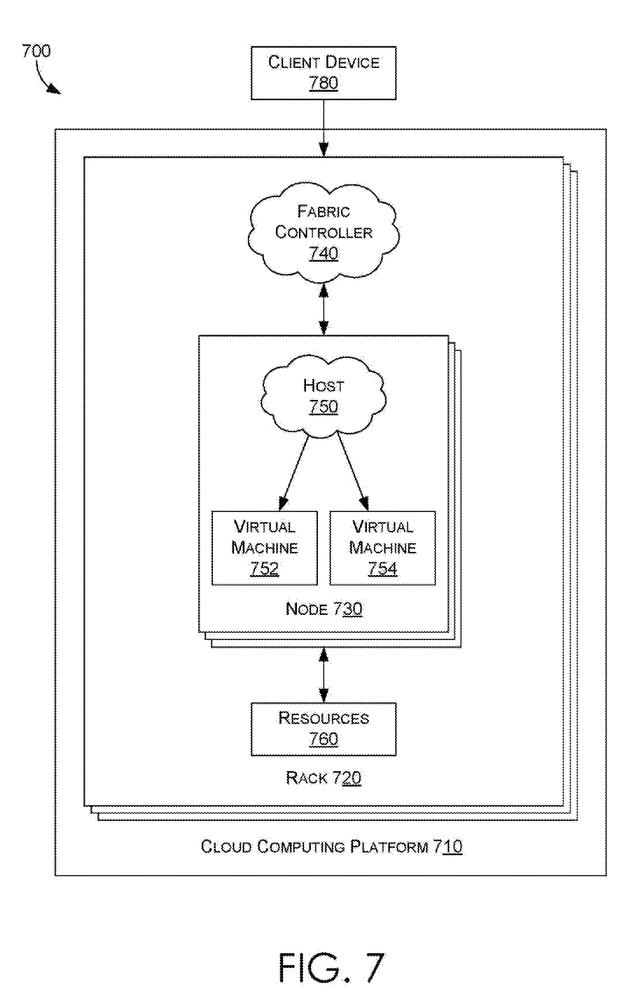

Referring now to FIG. 7, FIG. 7 illustrates an example distributed computing environment 700 in which implementations of the present disclosure may be employed. In particular, FIG. 7 shows a high-level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing platform 710 in a data center can be configured to host and support operation of endpoints of a particular service application. Cloud computing platform 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 800 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### EXAMPLE COMPUTING ENVIRONMENT

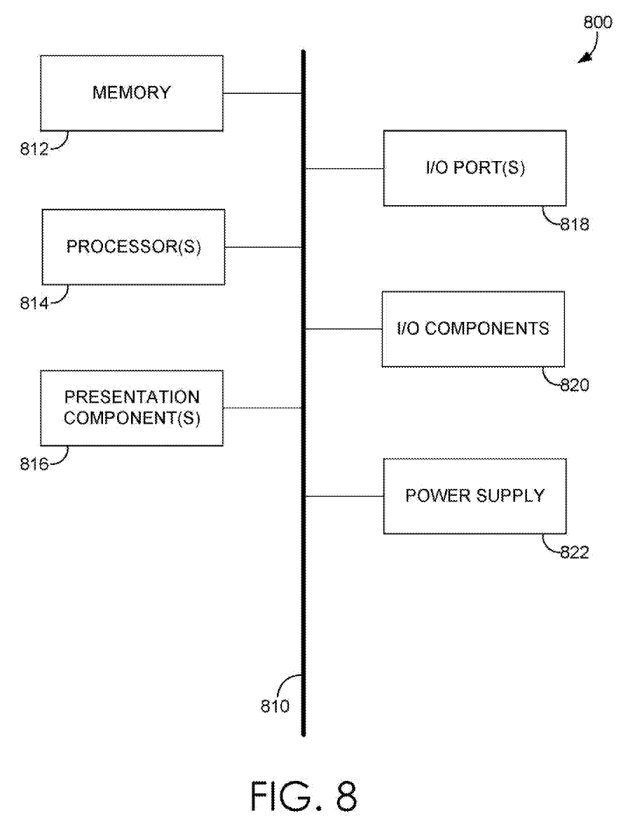

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### ADDITIONAL STRUCTURAL AND FUNCTIONAL FEATURES

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors;
computer memory storing computer-useable instructions that, when used by the one or more computer processors, cause the one or more computer processors to perform operations, the operations comprising:
authenticating an authorized user via a payment application associated with a payment platform;
receiving an indication to generate a temporary code, wherein the temporary code is a time-limited authorization token that allows a buyer to make a purchase on behalf of the authorized user;
based on receiving the indication to generate the temporary code, generating the temporary code;
receiving an indication to share the temporary code with the buyer; and
based on receiving the indication to share the temporary code, communicating the temporary code to a device associated with the buyer.

2. The system of claim 1, wherein the payment application is a mobile application that prompts the authorized user for authentication credentials and a two-factor authentication input for authenticating the authorized user.

3. The system of claim 1, wherein the indication to share the temporary code is received via a code-sharing interface of the payment application, wherein the code-sharing interface requests one or more of: a name of the buyer; a phone number of the buyer; and a spending limit for the purchase, wherein the code-sharing interface comprises a confirmation screen to confirm sharing the temporary code with the buyer.

4. The system of claim 1, wherein the temporary code is a one-time-use buyer code that supports making purchases without requiring the buyer to login or be onboarded to the payment platform.

5. The system of claim 1, wherein the payment application is associated with a track code status interface that provides temporary code information and provides a cancel code action for canceling temporary codes.

6. The system of claim 1, the operations further comprising receiving a purchase notification at the payment application after the buyer completes a transaction at a point-of-sale using the temporary code.

7. The system of claim 6, wherein the transaction is associated with an invoice comprising line-item view comprising descriptions for each line item and optionally one or more of the following: a name of the buyer, a total amount charged, and a time of the transaction.

8. The system of claim 1, wherein communicating the temporary code comprises communicating an electronic communication to a messaging endpoint associated with the device of the buyer,
wherein the electronic communication comprises the temporary code, a maximum amount authorized, and instructions for using the temporary code; and
wherein the temporary code is readable at a point-of-sale device to validate the temporary code for use with the purchase.

9. The system of claim 1, wherein the temporary code is associated with metadata that is linked to a record associated with the authorized user.

10. One or more computer-storage media having computer-executable instructions embodied thereon that, when executed by a computing system having a processor and memory, cause the processor to perform operations, the operations comprising:
accessing, at a point-of-sale device, a temporary code associated with a buyer, wherein the temporary code is a time-limited authorization token that allows the buyer to make a purchase on behalf of an authorized user;
communicating the temporary code to cause validation of the temporary code at a payment platform;
based on communicating the temporary code, receiving a validation response for the temporary code;
based on receiving the validation response, receiving an indication of identity verification of the buyer; and
based on the indication of identity verification of the buyer, processing a transaction using an account associated with the authorized user.

11. The media of claim 10, wherein the temporary code is validated via an Application Programming Interface (API) endpoint of the payment platform, wherein communicating the temporary code to cause validation of the temporary code is further based on communicating one or more of: a merchant identifier and point-of-sale metadata.

12. The media of claim 10, wherein the validation response comprises one or more of: an authorized user identifier; a name of the buyer; and a purchase limit; or wherein the validation response, if the temporary code is not validated, comprises a structured error message.

13. The media of claim 10, wherein the identity verification of the buyer is associated with a predefined identity verification method of the payment platform.

14. The media of claim 10, the operations further comprising, based on processing the transaction, communicating an indication to the payment platform that the temporary code has been used.

15. A computer-implemented method, the method comprising:
authenticating an authorized user via a payment platform associated with a payment application;
receiving an indication to generate a temporary code for a buyer, wherein the temporary code is a time-limited authorization token that allows the buyer to make a purchase on behalf of the authorized user;
based on receiving the indication to generate the temporary code, generating the temporary code;
communicating the temporary code to the payment application;
receiving, from a point-of-sale device, a request to validate the temporary code;
based on receiving the request, validating the temporary code at the payment platform; and
communicating a validation response to the request to cause processing a transaction based on temporary code.

16. The method of claim 15, the method further comprising communicating the temporary code to a device associated with the buyer.

17. The method of claim 15, wherein generating the temporary code comprises assigning metadata to the temporary code,
wherein the metadata comprises on or more of: an authorized user ID, buyer details, code expiration time stamps, purchase limit, and program-level enforcement flags, wherein a metadata record comprising the metadata is stored in linking data store.

18. The method of claim 15, wherein the validating the temporary code is based on one or more of: an existence and active status of the temporary code; expiration; usage status; purchase limit; and program-level authorization caps.

19. The method of claim 15, the method further comprising:
receiving an indication that the temporary code has been used, wherein based on receiving the indication, linking the transaction to an authorized user account,
wherein linking the transaction comprises adding metadata comprising one or more of: a name of the buyer, a temporary code used identifier; a timestamp, point-of-sale details, and purchase amount to the authorized user account.

20. The method of claim 19, the method further comprising:
triggering generation of an invoice having a line-item view comprising one or more of: a name of the buyer, a total amount charged, and a time of the transaction.
